(19) United States
(12) Patent Application Publication
(10) Pub. No.: US 2004/0015832 A1
(43) Pub. Date: Jan. 22, 2004

(54) Method and apparatus for generating source code

(76) Inventors: Michael Stapp, Westford, MA (US); Robert Morgan, Concord, MA (US)

Correspondence Address: THE HECKER LAW GROUP, 1925 CENTURY PARK EAST, SUITE 2300, LOS ANGELES, CA, 90067, US

(21) Appl. No.: 09/866,131

(22) Filed: May 25, 2001

(51) Int. Cl. G06F 9/44

(52) U.S. Cl. 717/106; 717/149

(57) ABSTRACT

Source code generation tools rely upon an architecture where the source to be generated is embedded in the application code. These tools may use a GUI layer to capture user's information, and transform the user's information into source by patching pieces of source code that is embedded in the application code and produce the source code. Because the code pieces used to generate the output are embedded in the application code itself, code modification requires programmers to edit the source code of the application itself and modify it.

The invention provides a method and apparatus for generating source code for computer programs. The method in the invention provides a set of tasks that are carried out to transform data in successive steps of data conversion. For example, a user may enter a set of data rules using a first specification language to describe a desired computer program. The invention provides a method to apply a suite of transformations to data resulting in the generation of source code capable of running in specific environments. The invention provides means for generating source code for whole new software applications, and for integrating newly generated source with existing projects and environments.

### FIELD OF THE INVENTION

This invention relates to the field of computer software development and more specifically to generating source code.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

Generating source code is an important step in the process of developing computer software applications. Source code comprises textual data written in a certain programming language that when compiled makes an executable application. Writing source code requires meticulous attention to detail. The author of the source code may, for example, be required to have knowledge of specific machine architecture requirements, syntax requirements, code layout standards, as well as many other factors. Since source code is traditionally written by hand, this step is known to take most of the development time. However, in software development time invested in the source code so that it conforms to the intended software design and architecture yields a better product. Furthermore, the requirements imposed by low-level machine architecture details, or by the specific programming language do not change significantly from one part of an individual application to another. Thus, to save time in the source code writing process, programmers use tools that are capable of interpreting design patterns to produce source code.

Several modern applications provide tools for generating source code for software applications. These tools may be part of an Integrated Development Environment (IDE), or as a standalone utility application. Usually, these tools provide a Graphical User Interface (GUI) capable of capturing user's input and producing source code. There are numerous advantages to source code generating tools. Programmers do not have to rewrite parts of source code that use similar design patterns. The graphical widgets usually allow for object creation and manipulation without requiring users to know the precise syntax of the objects source code. The tools rewrite the exact same code automatically, thus facilitating error tracking and correcting.

Existing source code generation tools rely upon an architecture where the source to be generated is embedded in the application code. Programmers of such source code generation applications often divide the applications into a GUI layer and an engine that patches pieces of source code either embedded as strings into the application code itself or stored externally in text files, and produce the source code. This architecture presents several serious weaknesses. When the code pieces used to generate the output are embedded as strings in the application code itself, code modification requires programmers to edit the source code of the application in order to modify the code. Furthermore, the programmer is required to have in-depth knowledge of the application's structure in order to properly edit the source code. For the end user, who may own only a compiled copy of the source code generating application, changes to the standards in the programming language and/or in the way software libraries are linked together render said application obsolete.

Other architectures are based on templates. Existing templates-based source code generation applications provide users with pre-defined templates that can be customized using a predefined language, and executed to generate the source code. Existing template-based source code generation applications are limited to very simple code patterns, since the templates allow for modifying the source code generated, however these application don't allow for changing the design pattern. For example existing template-based code generation applications offer very limited or non-existent flexibility in modifying the control logic, and poor integration with existing scripts.

Therefore, there is a need for a source code generation application that is independent of the implementation, and offers a high level of flexibility so that the end-users (programmers) may modify the output of the application without modifying the application itself.

### SUMMARY OF THE INVENTION

The invention provides a method and apparatus for generating source code for computer programs. The method in the invention provides a set of tasks that are carried out to transform data in successive steps of data conversion. For example, a user may enter a set of data rules using a first specification language to describe a desired computer program. The invention provides a method to apply a suite of transformations to data resulting in the generation of source code capable of running in specific environments. The invention provides means for generating source code for whole new software applications, and for integrating newly generated source with existing projects and environments.

Programmers may therefore utilize embodiments of the invention to generate a specification framework that can be turned into a functioning software program. For example, a programmer may utilize the invention to define the organization and/or architecture of a program and then automatically generate the source code (text written in one or more programming languages) that conforms to that definition. By allowing for such source code to be automatically generated according to a flexible framework the invention provides a mechanism that greatly improves upon existing methods for generating source code.

An embodiment of the invention uses a component model based on an object oriented architecture to structurally separate the User Interface (UI) components and the code-generation functionality components or modules. The components are capable of being accessed programmatically through other code or through a graphical user interface. An embodiment of the invention uses a pre-defined data structure that holds data required by the code generations component. The data can be validated using an XML parser to ensure nominal syntactic correctness.

An embodiment of the invention provides a mechanism for assisting programmers in generating JAVA Enterprise Edition compliant source code components. For example, a system in an embodiment of the invention may use standard Enterprise JavaBeans (EJB) as a component model architecture. However, in other embodiments of the invention the code-generation modules may be adapted to a plurality of different code-generation scenarios.

An embodiment of the invention uses XSLT templates for code generation in a manner that allows users to modify and add templates for generating code. The system configured in accordance with the invention may use a concept based on pipes-and-filters mechanism for generating code. The code generation container comprises a pipeline of one or more pairings of a pipe connector and a filter. A pipeline assembler assembles one or more pairings of a pipe connector and a filter and orders them properly based on a configuration provided by the user in a manner compatible with the handling of the data. When input data arrives at the code generation component's data input, data is processed by one filter then passed through to the next filter. This process continues until the last filter in the pipeline processes the data. The output of the pipeline is the source code files that are the result of successive transformations allowing user input to be checked for integrity and all class components generated.

### BRIEF DESCRIPTION OF THE DRAWINGS

FIG. 1 shows a block diagram that illustrates the separation between the user interface and the code generation components in accordance with one embodiment of the invention.

FIG. 2 shows a conceptual class diagram illustrating a design based on pipes-and-filters mechanism for generating code in an embodiment of the invention.

FIG. 3 shows a flowchart illustrating the data processing steps in calling the pipeline in an embodiment of the invention.

FIG. 4 shows a sequence diagram illustrating an error-handling protocol in the pipe connector in an embodiment of the invention.

FIG. 5 show a component diagram and the generalization relationships between components in an embodiment of the invention.

### DETAILED DESCRIPTION

An embodiment of the invention comprises a method and apparatus for generating software source code. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

The invention provides a method and apparatus for generating source code for software applications. Programmers may therefore utilize embodiments of the invention to generate a framework that can be turned into a functioning software program. For example, a programmer may utilize the invention to define the organization and/or architecture of a program and then automatically generate the source code (text written in one or more programming languages) that conforms to that definition. By allowing for such source code to be automatically generated according to a flexible framework the invention provides a mechanism that greatly improves upon existing methods for generating source code.

Embodiments of the invention use a component model based on an object oriented architecture to structurally separate the User Interface (UI) components and the code-generation functionality components or modules. This architecture enforces compile-time checks so that the code in one component doesn't use code from the other component. The components are capable of being accessed programmatically through other code or through a graphical user interface. An embodiment of the invention ensures that the code-generation functionality components may be used regardless of the method of code invocation. Furthermore, an embodiment of the invention minimizes or eliminates interdependencies between the graphical user interface (GUI) and code-generation code.

An embodiment of the invention uses a pre-defined data structure to hold the input data that the code-generation component requires. The UI component uses that data structure to communicate the data with other components. An embodiment of the invention uses Extensible Markup Language (XML) as a standard to represent the data. The data may be validated using an XML parser to ensure nominal syntactic correctness. An embodiment of the invention uses data templates to generate source code.

An embodiment of the invention provides a mechanism for assisting programmers in generating JAVA Enterprise Edition compliant source code components. The invention also implements the code-generation modules in a utility package independent of the EJB architecture. However, in other embodiments of the invention the code-generation modules may be adapted to a plurality of different code-generation scenarios.

The invention also provides users with a means to modify and add templates for generating code. By modifying and/or adding templates, programmers are enabled with the capability to modify the behavior of the source generating modules. This allows users to generate new source code without editing and manipulating the source code of the source code generating application. An embodiment of the invention uses XSLT templates for code generation (e.g., in contrast to markup generation). XSLT provides both a template language for creating templates and a runtime mechanism for transforming XML data into another form according to the template rules.

To encapsulate these source code generating modules and data structures, one embodiment of the invention utilizes an object oriented programming (OOP) language approach. One or more embodiments of the invention also generates source code in one or any of the Java language, Enterprise JavaBeans, Java Server Pages, the Extensible Markup Language (XML), the Extensible Stylesheet Language (XSL), and the Extensible Stylesheet Language Transformation (XSLT).

To provide the reader with an understanding of encapsulation of related modules of the source code generating method and data structures, an overview of object-oriented programming, XML, XSL and XSLT are provided below.

Object-Oriented Programming:

Object-oriented programming is a method of creating computer programs by combining certain fundamental building blocks, and creating relationships among and between the building blocks. The building blocks in object-oriented programming systems are called “objects.” An object is a programming unit that groups together a data structure (one or more instance variables) and the operations (methods) that can use or affect that data. Thus, an object consists of data and one or more operations or procedures that can be performed on that data. The joining of data and operations into a unitary building block is called “encapsulation.”

An object can be instructed to perform one of its methods when it receives a “message.” A message is a command or instruction sent to the object to execute a certain method. A message consists of a method selection (e.g., method name) and a plurality of arguments. A message tells the receiving object what operations to perform.

One advantage of object-oriented programming is the way in which methods are invoked. When a message is sent to an object, it is not necessary for the message to instruct the object how to perform a certain method. It is only necessary to request that the object execute the method. This greatly simplifies program development.

Object-oriented programming languages are predominantly based on a “class” scheme. The class-based object-oriented programming scheme is generally described in Lieberman, “Using Prototypical Objects to Implement Shared Behavior in Object-Oriented Systems,” OOPSLA 86 Proceedings, September 1986, pp. 214-223.

A class defines a type of object that typically includes both variables and methods for the class. An object class is used to create a particular instance of an object. An instance of an object class includes the variables and methods defined for the class. Multiple instances of the same class can be created from an object class. Each instance that is created from the object class is said to be of the same type or class.

To illustrate, an employee object class can include “name” and “salary” instance variables and a “set_salary” method. Instances of the employee object class can be created, or instantiated for each employee in an organization. Each object instance is said to be of type “employee.” Each employee object instance includes “name” and “salary” instance variables and the “set_salary” method. The values associated with the “name” and “salary” variables in each employee object instance contain the name and salary of an employee in the organization. A message can be sent to an employee's employee object instance to invoke the “set-salary” method to modify the employee's salary (i.e., the value associated with the “salary” variable in the employee's employee object).

A hierarchy of classes can be defined such that an object class definition has one or more subclasses. A subclass inherits its parent's (and grandparent's etc.) definition. Each subclass in the hierarchy may add to or modify the behavior specified by its parent class. Some object-oriented programming languages support multiple inheritances where a subclass may inherit a class definition from more than one parent class. Other programming languages support only single inheritance, where a subclass is limited to inheriting the class definition of only one parent class.

An object is a generic term that is used in the object-oriented-programming environment to refer to a module that contains related code and variables. A software application can be written using an object-oriented programming language whereby the program's functionality is implemented using objects. The encapsulation provided by objects in an object-oriented programming environment may be extended to the notion of transactions, allocations, quotas, quota details, quota states, and promotions as discussed below.

In one embodiment of the invention, a shell object mechanism is utilized to store and provide access to objects and data. Such a mechanism is discussed in detail in pending U.S. patent application Ser. No. 08/931,878 entitled “Method and Apparatus for Providing Peer Ownership of Shared Objects” which is hereby incorporated by reference.

Java Programming Language as An OOP Language

Examples of object-oriented programming languages include C++ and Java®. Unlike most programming languages, in which a program is compiled into machine-dependent, executable program code, Java classes are compiled into machine independent byte-code class files which are executed by a machine-dependent virtual machine. The virtual machine provides a level of abstraction between the machine independence of the byte-code classes and the machine-dependent instruction set of the underlying computer hardware. A class loader is responsible for loading the byte-code class files as needed, and an interpreter or just-in-time compiler provides for the transformation of byte-codes into machine code.

JavaBeans and Enterprise JavaBeans™

JavaBeans™ is an object-oriented programming architecture that lets programmers build program building blocks called components using the Java programming language. JavaBeans architecture is maintained and kept by Sun Microsystems™. Components built on the JavaBeans component model can be deployed in a network on any major operating system platform. JavaBeans components can be used to give applications interactive capabilities. For example, a web page can be enabled with interactive capabilities such as buttons and small applications using JavaBeans. From a user's point-of-view, a component such as a button or the embedded application, are all widgets with which the user can interact to perform a certain task. From a developer's point-of-view, the button component and the calculator component are created separately and can then be used together or in different combinations with other components in different applications or situations. When the components or Beans are in use, the properties of a Bean (for example, the background color of a window) are visible to other Beans and Beans that haven't “met” before can learn each other's properties dynamically and interact accordingly. Beans are developed with a Beans Development Kit (BDK) from Sun and can be run on any major operating system platform (Windows 95, UNIX, Mac) inside a number of application environments (known as containers), including browsers, word processors, and other applications. To build a component with JavaBeans, a programmer writes language statements using Sun's Java programming language and include JavaBeans statements that describe component properties such as user interface characteristics and events that trigger a bean to communicate with other beans in the same container or elsewhere in the network. Beans also have persistence, which is a mechanism for storing the state of a component in a safe place. This would allow, for example, a component (bean) to retrieve data that a particular user had already entered in an earlier user session.

Enterprise JavaBeans™ (EJB) is a specification for setting up program components that run in the server parts of a computer network that uses the client/server model. Enterprise JavaBeans™ architecture is built on the JavaBeans technology for distributing program components to clients in a network. Enterprise JavaBeans components enable applications to control change at the server rather than having to update each individual computer with a client application whenever a new program component is changed or added. EJB components have the advantage of being reusable in multiple applications. To deploy an EJB Bean or component, it must be part of a specific application, which is called a container. EJB's program components are generally known as servlet (little server programs). The application or container that runs the servlets is sometimes called an application server. A typical use of servlets is to replace Web programs that use the Common Gateway Interface (common gateway interface) and a Practical Extraction and Reporting Language script. Another general use is to provide an interface between Web users and a legacy application mainframe application, and its database. In Enterprise JavaBeans, there are two types of beans: session beans and entity beans. An entity bean is described as one that, unlike a session bean, has persistence and can retain its original behavior or state.

EJB technology is the core of Java 2 Enterprise Edition (J2EE). It enables developers to write reusable portable server-side business logic for the J2EE platform. The following rules are followed in the EJBs specifications:

EJB components are server-side components written entirely in the Java programming language

EJB components contain business logic only, and no system-level programming

System-level services such as transactions, security, Life-cycle, threading, persistence, etc. are automatically managed for the EJB component by the EJB server

EJB architecture is inherently transactional, distributed, portable, multi-tier, scalable and secure

Components are declaratively customized. (Can customize: transactional behavior, security features, life-cycle, state management, persistence, etc.)

EJB components are fully portable across any EJB server and any operating system

Java Server Pages

JavaServer Pages (JSP) technology is an extension of the Java™ Servlet technology. JavaServer Pages™ technology allows web developers and designers to develop dynamic web pages. JavaServer Pages technology uses XML-like tags and scriptlets written in the Java programming language to encapsulate the logic that generates the content for the page. Additionally, the application logic can reside in server-based resources (such as JavaBeans™ component architecture) that the page accesses with these tags and scriptlets. The JSP server generates Web pages by combining the formatting (HTML or XML) tags and the data generated by the server resources (e.g. Servlets and EJBs). JSP technology separates the user interface from content generation enabling designers to change the overall page layout without altering the underlying dynamic content or the content generation code.

Extensible Markup Language (XML)

Extensible Markup Language (XML) is a human-readable, machine-understandable, general syntax for describing hierarchical data. XML is an open standard for describing data developed under the auspices by the World Wide Web Consortium (W3C). XML is a subset of the Standard Generalized Markup Language (SGML) defined in ISO standard 8879:1986. XML is a formal language that can be used to pass information about the component parts of a document from one computer system to another. XML is used to describe any logical text structure (e.g. form, book, database etc.). XML is based on the concept of documents composed of a series of entities. Each entity can contain one or more logical elements. Each of these elements can have certain attributes (properties) that describe the way in which it is to be processed. XML also provides a formal syntax for describing the relationships between the entities, elements and attributes that make up an XML document, such a syntax can be used to recognize component parts of each document.

XML differs from other markup languages in that it does not simply indicate where a change of appearance occurs, or where a new element starts. XML clearly identifies the boundaries of every part of a document, (e.g. whether a text block is new chapter, or a reference to another publication). XML uses custom tags enabling applications to define, transmit, validate and interpret data shared between applications and between organizations.

To allow a computer to check the structure of a document, users must provide it with a document type definition that declares each of the permitted entities, elements and attributes, and the relationships between them. By defining the role of each element of text in a formal model, known as a Document Type Definition (DTD), users of XML can check that each component of document occurs in a valid place within the interchanged data stream. An XML DTD allows computers to check, for example, that users do not accidentally enter a third-level heading without first having entered a second-level heading, something that cannot be checked using the HyperText Markup Language (HTML) previously used to code documents that form part of the World Wide Web (WWW) of documents accessible through the Internet. However, XML does not restrict users to using DTDs.

To use a set of markup tags that has been defined by a trade association or similar body, users need to know how the markup tags are delimited from normal text and in which order the various elements should be used. Systems that understand XML can provide users with lists of the elements that are valid at each point in the document, and will automatically add the required delimiters to the name to produce a markup tag. Where the data capture system does not understand XML, users can enter the XML tags manually for later validation. Elements and their attributes are entered between matched pairs of angle brackets (< . . . >) while entity references start with an ampersand and end with a semicolon (& . . . ;).

Because XML tag sets are based on the logical structure of the document they are somewhat easier to understand than physically based markup schemes of the type typically provided by word processors. As an example, a memorandum coded in XML might look as follows:

<memo>
<to>All staff</to>
<from>R. Michael</from>
<date>April 1, 2001</date>
<subject>Power Saving</subject>
<text>Please turn off your desktops before you leave.</text>
</memo>

As shown in the example above, the start and end of each logical element of the file has been clearly identified by entry of a start-tag (e.g. <to>) and an end-tag (e.g. </to>). This formatting is ideal for a computer to follow, and therefore for data processing.

To define tag sets users may create a Document Type Definition that formally identifies the relationships between the various elements that form their documents. For the simple memorandum example, the XML DTD might take the form:

| | |
|---|---|
| <!DOCTYPE memo [ | |
| <!ELEMENT memo | (to, from, date, subject?, para+) > |
| <!ELEMENT para | (#PCDATA) > |
| <!ELEMENT to | (#PCDATA) > |
| <!ELEMENT from | (#PCDATA) > |
| <!ELEMENT date | (#PCDATA) > |
| <!ELEMENT subject | (#PCDATA) > |
| ] > | |

This model indicates that a memorandum consists of a sequence of header elements, <to>, <from>, <date> and, optionally, <subject>, which must be followed by the contents of the memorandum. The content of the memo defined in this simple example is made up of a number of paragraphs, at least one of which must be present (this is indicated by the + immediately after para). In this simplified example a paragraph has been defined as a leaf node that can contain parsed character data (#PCDATA), i.e. data that has been checked to ensure that it contains no unrecognized markup strings.

XML validation and well formedness can be checked using XML processors to which it is commonly referred as XML parsers. An XML processor parser checks whether an XML document is valid by checking that all components are present, and the document instance conforms to the rules defined in the DTD.

Extensible Stylesheet Language (XSL)

Extensible Stylesheet Language (XSL) is a language for creating a style sheet that describes how data sent to a user using the Extensible Markup Language is to be presented. XSL is based on, and extends the Document Style Semantics and Specification Language (DSSSL) and the Cascading Style Sheet, level 1 (CSS1) standards. XSL provides the tools to describe exactly which data fields in an XML file to display and exactly where and how to display them. XSL consists of two parts: a language for transforming XML documents, and an XML vocabulary for specifying formatting semantics. For example, in an XML page that describes the characteristics of one or more products from a retailer, a set of open and close tags, designating products manufacturers, might contain the name of the product manufacturer. Using XSL, it is possible to dictate to a browser on a computer the placement on a page, and the display style of the manufacturer's name.

Like any style sheet language, XSL can be used to create a style definition for one XML document or reused for many other XML documents.

Extensible Stylesheet Language Transformation (XSLT)

Extensible Stylesheet Language Transformation (XSLT) is a language for transforming XML documents into other XML documents. The specification of the syntax and semantics of XSLT is developed under the auspices of the World Wide Web Consortium (W3C).

XSLT is designed for use as part of XSL. XSL describes the styling of an XML document that uses the formatting vocabulary, and uses XSLT to describe how the document is transformed into another XML document that uses the formatting vocabulary. However, XSLT is also designed to be used independently of XSL.

Source Code Generation Assistant

The invention proposes a method and apparatus for generating source code based on user input. The invention can be used, for example, by programmers to generate Java language source code for software applications.

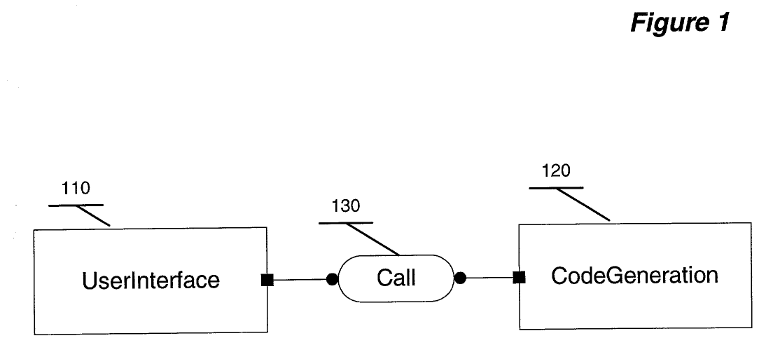

An embodiment of the invention uses a design for separating the components comprising a user interface (UI) and code generation components. FIG. 1 shows a block diagram that illustrates the separation between the user interface 110 and the code generation 120 components. Components 110 and 120 are linked through relationship 130. An embodiment of the invention provides means for bypassing the UI and accessing the code generation functionality in 120 directly. For example, a programmer may use an Application Programming Interface (API) to communicate data and make direct calls to the code generation components at runtime in an application.

FIG. 1 describes a conceptual diagram in an embodiment of the invention. This design describes the system's major functionality in terms of components and the relationships among them. The elements of these diagrams may not map one-to-one to actual code classes, it is an illustration of the design concepts and not the implementation of those concepts. Each component in the diagram is the locus of functionality and state. A component specific visible interface points are its ports; they are often named. A conceptual connector 130 is the locus of relations among components, and of control. A relation component such as 130 comprises roles to be filled in the relation, and protocols for the interaction among those roles.

User Interface Component

An embodiment of the invention provides a user interface (UI) to assist users input and communicate data to the code generation component. The UI in the invention presents multiple screens to the user allowing for choosing among previously developed object templates. For example, an embodiment of the invention allows a user to choose the type of EJB. The user may create an EJB while choosing between an Entity EJB and a Session EJB. The UI in the invention allows a user to further specify if the EJB should be created anew or from an existing object.

An embodiment of the invention provides means to user to enter data for the newly created objects. For example, the UI allows users to enter the Entity name and specify attributes and properties (e.g. base, remote, home, implementation, primary key). The UI is designed to guide and assist the user in entering information and checking data integrity during the process of building objects.

An embodiment of the invention captures the user input as an XML tree and writes the code-generation templates as a set of XSLT templates. The UI provides means to users to choose from several templates. For example, in the process of creating a source code for a widget, a user may specify a type of EJB. The UI associates, in the background, the EJB type displayed to the user with a named set of templates. The set of templates contains rules for transforming the XML data into the specific type of source code that will be generated (e.g. type of class, class mutators, set of class attributes and properties, class input and output). The task of generating the code is carried out by transforming the user input XML according to each of the relevant XSLT templates.

In an embodiment of the invention, the separation of user data (the source XML data) from the process of generating code (running the XSLT transformations) provides suitable means to modularize the functionality into user interface and code generation modules.

Overall Component Design for Generating Source Code

In an embodiment of the invention, the code generation component 120 provides means to carry out several distinct stages of data processing (e.g. determine what code to generate, generate code, write out files, etc.), and allows each stage to transform or add to the input data. The invention contemplates providing means for making the processing stages adaptable depending on the context in which the code generation module is used. For example, in an embodiment of the invention, different generation scenarios using different number, type, and functionality of the stages may be used depending upon the context of the code generation.

An embodiment of the invention uses the concept of pipes and filters to implement succeeding stages of processing. Typically pipes refer to the way data is communicated between processes. Here, the term “pipe” is used to refer to any type of communication between processing stages. For example, processing stages may input and output data to the standard input/output. Processes may also input and output data to flat files, network enabled objects (e.g. EJBs, CORBA objects, Databases) and any type of communication between processing modules.

An embodiment of the invention implements the concept of filters. A “filter” refers to a module that takes the input data and transforms it or acts on that data and produces an output. For example, an XML parser may be viewed as a filter. The XML parser may use a DTD to check the XML integrity and produces output data ready for use by other modules.

Unlike the implementations of pipes and filters in many computer environments, an embodiment of the invention implements sharing of states among pipes and filters. In addition to sharing states, the pipes and filters may require blocks of data or complete input data before processing, and may generate a single block of output data.

An embodiment of the invention makes use of a set pipes and filters in the context of an EJB, JSP, Servlets, Java class source generator and any program module or configuration data according to any language standard and any extension thereof.

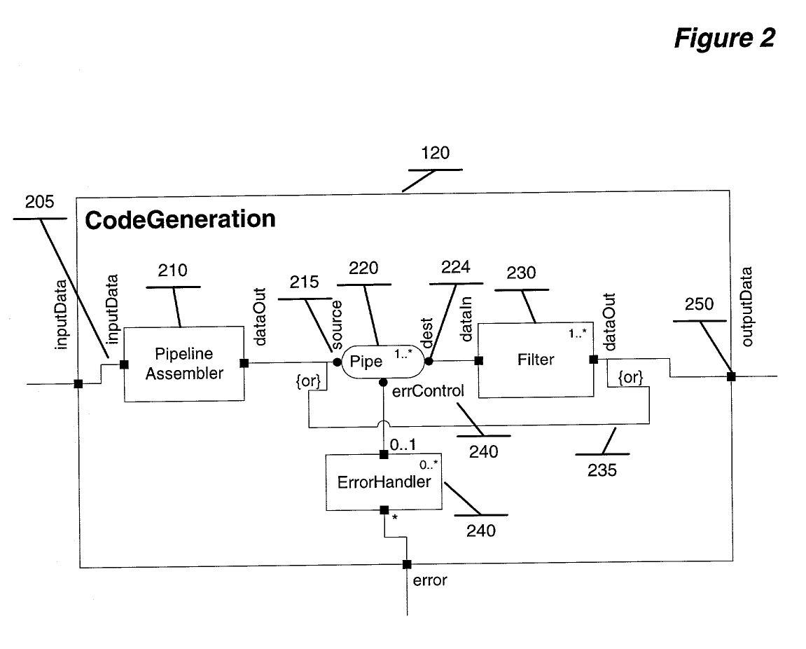

FIG. 2 shows a conceptual class diagram illustrating a design based on pipes-and-filters mechanism for generating code in an embodiment of the invention. The code generation component 120 is a container comprising a pipeline assembler component 210, and one or more pairings of a pipe connector 220 with a filter component 230. Each pipe-and-filter pairing (220 and 230) may have an error handler 240 component as well. Each filter's data output port 235 plays the source role of the next pipe connector 215 in the pipeline. The last filter in the chain connects directly to data output port 250 of the code generation component (container component). The pipeline assembler 210 reads the data configuration and assembles the pipes and filters and orders them appropriately to handle data. In an embodiment of the invention, the pipe connector 220 controls both the calling of the filter and the handling of any errors the filter reports. In an embodiment of the invention, the error handler mechanism 240 is made separate from the filter component 230 so that error-handling code can be shared among different filters, and provide flexibility to handle errors from a single filter in several ways depending on the context.

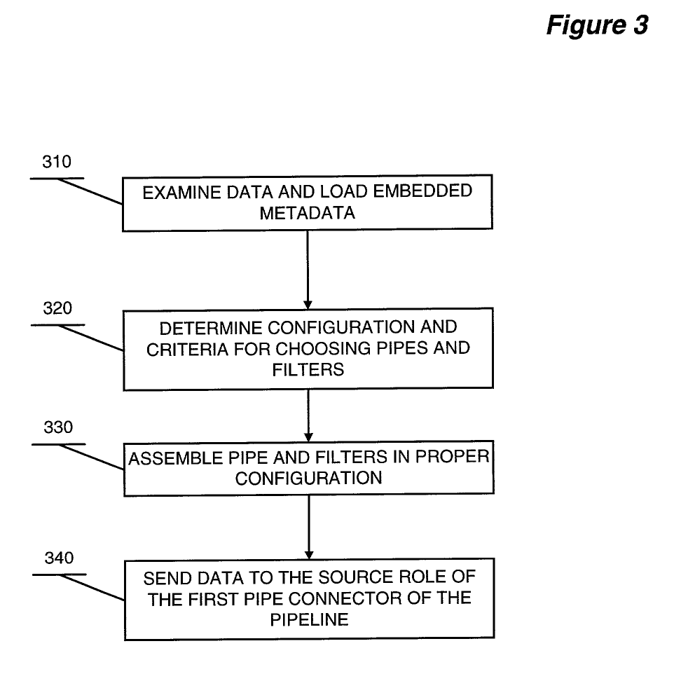

FIG. 3 shows a flowchart illustrating some of the data processing steps in the code generation component in an embodiment of the invention. When input data arrives at the code generation component's data input port 205, the pipeline assembler 210 reads the configuration parameters from the data in step 310. In an embodiment of the invention, the configuration data and criteria for choosing the appropriate filters and pipelines may be stored as embedded metadata (e.g. XML tags). The pipeline assembler examines the configuration data, and determines the appropriate pipeline configuration in step 320 using a lookup table that stores information about filters and pipes. The pipeline assembler 210 then creates the necessary pipe-and-filter instances and assembles said pipes and filters in the proper order in step 330. Once the pipeline is assembled, the pipeline assembler sends the data to the source role of the first pipe connector in the pipeline in 340.

The pipe connector gives control to its associated filter component. Each filter performs its processing on the input data, and pushes the result out of its dataout port. This continues until data processing reaches the last filter in the pipeline. The data is then output through the code generation container data output port 250.

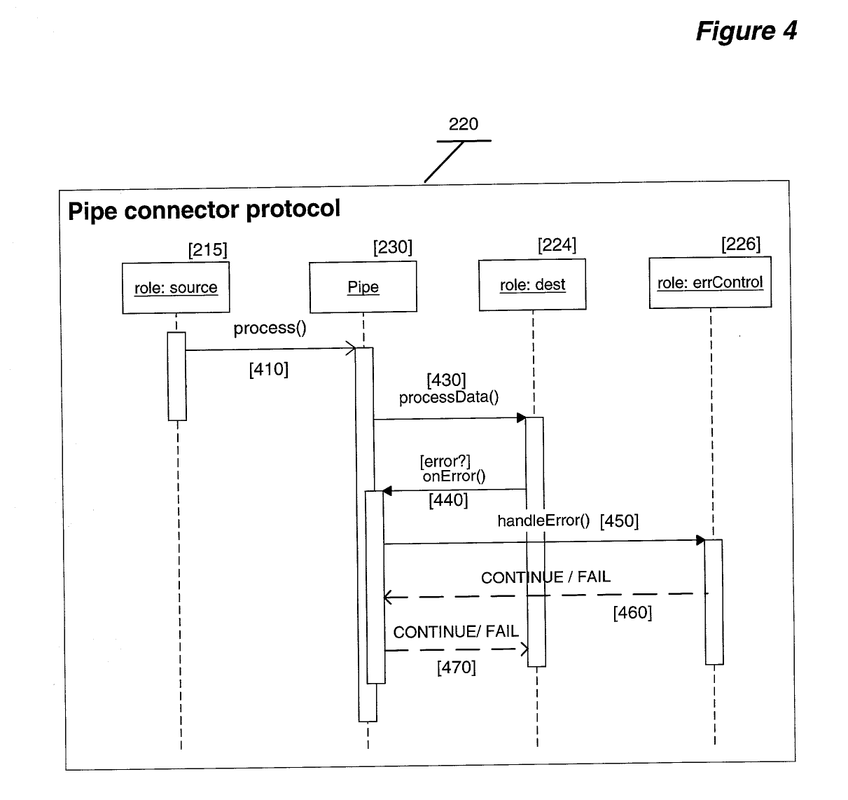

FIG. 4 shows a sequence diagram illustrating an error-handling protocol in the pipe connector in an embodiment of the invention. The source object 215 issues a message 410 indicating that data is ready to be forwarded through the pipe 230. The pipe forwards the data in 430 to the destination role 224. If the destination role 224 encounters an error condition, it calls back in 440 the Pipe connector. The pipe connector may delegate in 450 error handling to the error control role 226. The error handler determines whether the pipeline should continue processing or not, and returns a CONTINUE or FAIL code in 460. The Pipe connector returns this value back to the destination object in 470. The destination object 224 revises the data in view of the error and either continues processing or issues an error message.

Source Code Generation

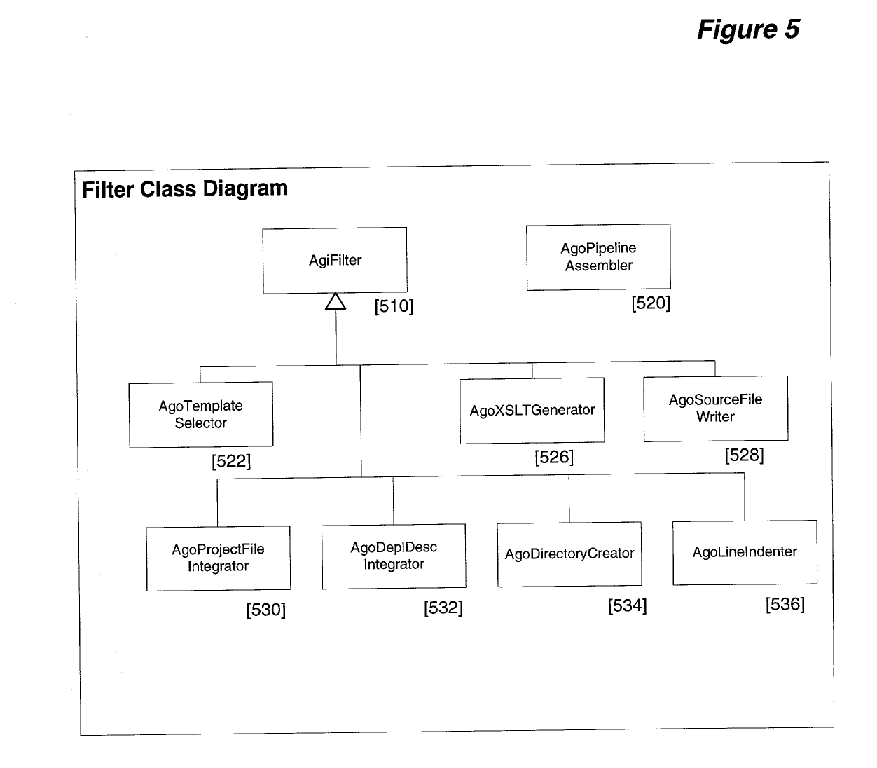

An embodiment of the invention provides means to generate source code. The embodiment of the invention implements the component model described above. FIG. 5 show a component diagram and the generalization relationships between components in an embodiment of the invention.

An interface component 510 (AgiFilter) may be implemented for the pipes-and-filters processor (Pipeline Processor). This component provides the means to instruct the filter to process the input data. If the call is successful, the interface may or may not return a return code, and the calling code handle transferring control to the next pipe segment. If an error is detected, the filter calls back the calling pipe and the return code from that call will indicate to said filter instance whether to continue processing or to abort and return. This interface's 510 derived classes 522, 526, 528, 530, 532, 534 and 536 share state by using a standardized communication language. In an embodiment of the invention, these classes share states using an XML data set. This tree of data has a number of main branches off of the root node, such as InputData (from the UI Wizard or calling API), CodeGenerationTemplates (holds the appropriate XSLT templates for the current input data), GeneratedCode, etc. Each Filter either modifies the shared state or performs some external action based on the state (i.e., AgoSourceFileWriter writes out the generated source code files using the data in the shared state).

Component 520 (AgoPipelineAssembler) is the concrete class that implements the PipelineAssembler component, discussed above. It is not a Filter class, and is used explicitly by the Code Generation component to create the Filters. It uses a table-driven mechanism to select and instantiate the specific Filters needed for a code generation task.

A component 522 (AgoTemplateSelector) uses the XML input data to choose the appropriate XSLT template for code generation, based on the given input data. The code generator will use different templates depending upon a number of input parameters, such as whether the target EJB is an entity or session bean, and even possibly if it's a stateless or stateful session EJB, or bean- or container-managed entity EJB. An embodiment of the invention uses a simple table lookup; wherein users can add to the table's metadata to include their own templates and selection criteria. Component 522 is a Filter for the pipes-and-filters processor. It finds the appropriate XSLT template based on a specific DOM element type and attribute value in the source-data XML. This value is itself a key that is used to lookup the actual XSLT template file in the framework's properties values. If no error is found, additional XML data is created appropriately as a result of processing the XSLT template, and put into the existing XML data for later filters to use.

Component 526 (AgoXSLTGenerator) transforms XML input data into another form of XML data using a set of XSLT templates chosen by component 522 (AgoTemplateSelector). This class provides access to the XSLT engine.

Component 528 (AgoSourceFileWriter), for example, may be configured to extract the generated source code nodes from the XML tree and writes them out as files. The XML input data contains the destination path for the files. The source code generated by the XSLT processor is one XML node per file. Component 528 (AgoSourceFileWriter) writes out each node to its appropriately-named file. This class is a Filter for the pipes-and-filters processor.

In an embodiment of the invention component 530 (AgoProjectFilelntegrator) integrates generated project-file additions into specified project files. This class is a Filter for the pipes-and-filters processor. In an embodiment of the invention this class has a method (processData) Method to interface with AgiFilter. This implementation looks for the node in data, determines whether each generated source code file that it finds under that element is a candidate for updating a project file. If so, it locates the specified open project file and integrates the generated elements into that file.

Component 532 (AgoDeplDescIntegrator) includes abstract methods for reading and writing the deployment descriptor data. Component 532 provides one or more methods looking for the nodes in data, determining whether each generated source code file that it finds under that element is a candidate for updating a deployment-descriptor file. If so, it locates the specified deployment-descriptor file and integrates the generated elements into that file.

In an embodiment of the invention component 534 (AgoDirectoryCreator) ensures that all of the necessary directories exist before the pipeline's file-writing filter tries to write out the files. Component 532 may require to be called AFTER the XSLT generator has generated the source code (in the XML tree). In an embodiment of the invention, this class reads all of the nodes, and makes sure all of the referenced directories exist. This class is a Filter for the pipes-and-filters processor.

In an embodiment of the invention component 536 (AgoLineIndenter) replaces the indentation characters in the generated code with the user's chosen indent tokens. This class relies on an “indent-token” attribute in the source XML's element to determine the current indentation scheme. In an embodiment of the invention, this class may replace an entire sub-tree with a new one that contains a single text element child, which is the re-indented version of the old sub-tree consolidated into a single text node. This class is a Filter for the pipes-and-filters processor.

Thus a method and apparatus for generating source code is described in conjunction with one or more specific embodiments. The invention is defined, however, by the claims and their full scope of equivalents.

What is claimed is:

1. A method for generating source code comprising:
obtaining user specification for generating program code in a standard format language;
constructing a processing pipeline comprising one or more pairings of pipes and filters for processing data; and
translating said specifications into a program source code using said pipeline.

2. The method of claim 1 wherein said step of obtaining user specification further comprises presenting one or more data captures screens.

3. The method of claim 1 wherein said step of obtaining user specification further comprises writing out said specification in one or more XML data nodes.

4. The method of claim 1 wherein said step of obtaining user specification further comprises capturing user data for generating Enterprise JavaBeans.

5. The method of claim 1 wherein said step of obtaining user specification further comprises capturing user data for generating servlets.

6. The method of claim 1 wherein said step of obtaining user specification further comprises capturing user data for generating Java Server Pages.

7. The method of claim 1 wherein said step of obtaining user specification further comprises capturing user data for generating Java classes.

8. The method of claim 1 wherein said step of obtaining user specification further comprises using an API to specify user data.

9. The method of claim 1 wherein said step of obtaining user specification further comprises modifying a set of XSLT templates for generating source code.

10. The method of claim 1 wherein said step of constructing a processing pipeline further comprises reading configuration data.

11. The method of claim 1 wherein said step of constructing a processing pipeline further comprises looking up in a lookup table a set of appropriate filters.

12. The method of claim 1 wherein said step of constructing a processing pipeline further comprises selecting one or more XSLT templates.

13. The method of claim 1 wherein said step of constructing a processing pipeline further comprises connecting said one or more pairings of pipes and filters.

14. The method of claim 13 wherein said step of connecting said one or more pairings of pipes and filters further comprises performing said connecting based on a context.

15. The method of claim 1 wherein said step of translating said specifications further comprises calling an XSL engine.

16. The method of claim 1 wherein said step of translating said specifications further comprises streaming data between said one or more pairings of pipes and filters.

17. The method of claim 16 wherein said step of streaming data further comprises checking for errors in the data.

18. A computer program product comprising:
a computer usable medium having computer readable program code for generating source code embodied therein, said computer readable program code configured to:
obtain user specification for generating program code in a standard format language;
construct a processing pipeline comprising one or more pairings of pipes and filters for processing data; and
translate said specifications into a program source code using said pipeline.

19. The computer program product of claim 18 wherein said computer readable program code configured to obtain user specification further comprises presenting one or more data captures screens.

20. The computer program product of claim 18 wherein said computer readable program code configured to obtain user specification further comprises writing out said specification in one or more XML data nodes.

21. The computer program product of claim 18 wherein said computer readable program code configured to obtain user specification further comprises capturing user data for generating Enterprise JavaBeans.

22. The computer program product of claim 18 wherein said computer readable program code configured to obtain user specification further comprises capturing user data for generating servlets.

23. The computer program product of claim 18 wherein said computer readable program code configured to obtain user specification further comprises capturing user data for generating Java Server Pages.

24. The computer program product of claim 18 wherein said computer readable program code configured to obtain user specification further comprises capturing user data for generating Java classes.

25. The computer program product of claim 18 wherein said computer readable program code configured to obtain user specification further comprises using an API for specifying user data.

26. The computer program product of claim 18 wherein said computer readable program code configured to obtain user specification further comprises modifying a set of XSLT templates for generating source code.

27. The computer program product of claim 18 wherein said computer readable program code configured to construct a processing pipeline further comprises reading configuration data.

28. The computer program product of claim 18 wherein said computer readable program code configured to construct a processing pipeline further comprises looking up in a lookup table a set of appropriate filters.

29. The computer program product of claim 18 wherein said computer readable program code configured to construct a processing pipeline further comprises selecting one or more XSLT templates.

30. The computer program product of claim 18 wherein said computer readable program code configured to construct a processing pipeline further comprises connecting said one or more pairings of pipes and filters.

31. The computer program product of claim 30 wherein said computer readable program code configured to connect said one or more pairings of pipes and filters further comprises performing said connecting based on a context.

32. The computer program product of claim 18 wherein said computer readable program code configured to translate said specifications further comprises calling an XSL engine.

33. The computer program product of claim 18 wherein said computer readable program code configured to translate said specifications further comprises streaming data between said one or more pairings of pipes and filters.

34. The computer program product of claim 33 wherein said computer readable program code configured to stream data further comprises checking for errors in the data.
